(19) United States
(12) Patent Application Publication
(10) Pub. No.: US 2023/0419171 A1
(43) Pub. Date: Dec. 28, 2023

(54) ENERGY-EFFICIENT SAMPLE SELECTION METHOD BASED ON COMPLEXITY

(71) Applicant: Northwestern Polytechnical University, Xi An (CN)

(72) Inventors: Yunji Liang, Xi An (CN); Qiushi Wang, Xi An (CN); Hangyu Hu, Xi An (CN); Zhiying Zhao, Xi An (CN); Lei Liu, Xi An (CN)

(21) Appl. No.: 17/956,170

(22) Filed: Sep. 29, 2022

(30) Foreign Application Priority Data
Jun. 24, 2022 (CN) 202210727797.X

(51) Int. Cl. G06N 20/00

(52) U.S. Cl. CPC G06N 20/00

(57) ABSTRACT

The invention discloses an energy-efficient sample selection method based on sample complexity, which performs sample selection on the raw data sets through two stages of inter-class sampling and intra-class sampling, the object is to select representative samples from large-scale data sets, thereby reducing the number of samples used for model training and achieving the object of lightweight training. Compared with the prior art, the invention has the following advantages: the invention proposes an energy-efficient sample selection method based on complexity, selects representative samples from large-scale datasets for efficient model training, and proves that sample complexity and model training strategies have a very important impact on the efficient training of deep neural networks. The invention also solves the problem of low efficiency of model training based on sample complexity and model training strategies, which has certain significance for alleviating the problem of low efficiency of deep learning model training.

### 1. TECHNICAL FIELD

The invention relates to the field of deep neural network training on data sets, in particular to an energy-efficient sample selection method based on complexity.

### 2. BACKGROUND

With the resurgence of deep neural network architectures and the improvement of GPU computing power, deep neural networks have shown amazing performance in many computer vision tasks. However, training deep neural networks on large-scale datasets is inefficient. The reasons are summarized as follows: first of all, the scale of the neural network is getting deeper and deeper, and the whole network has more than millions of parameters, the explosive growth of the scale of model makes the training of the neural network difficult; second, the training of deep neural network requires a large number of labeled data samples to update the model weights. Therefore, training deep neural network on large-scale datasets is inefficient, and the training process requires higher computing power.

### 3. SUMMARY OF THE INVENTION

The technical problem to be solved by the invention is that the deep neural network training on large-scale data sets needs to consume higher computing power and energy consumption, and the training efficiency is low.

In order to solve the above technical problems, the invention provides a technical scheme: an energy-efficient sample selection method based on complexity, which performs sample selection on the raw data sets through two stages of inter-class sampling and intra-class sampling to achieve the object of constructing lightweight data set for model training. Wherein:
inter-class sampling, inter-class sampling is performed through reverse diverse self-paced learning, specifically the reverse diverse self-paced learning algorithm:
input: target data set D
output: model parameter w,
1) i←0; ←+∞; ←+∞;
2) if there is no prior clustering, then
3) set the number of clusters to the number of classes;
4) end if;
5) while not converged do;
6) update w*=argmin_{w}E(w, v*; λ, γ);
7) use Algorithm 1 to update v□=argminᵥE(w^{□}, v; λ, γ);
8) λ←(1−e⁻ⁱ)λ; γ←(1−e⁻ⁱ)γ;
9) i++;
10) end while;
11) return w=w^{□};
intra-class sampling is performed by a density-based sampling strategy, specifically an efficient intra-class sampling algorithm based on complexity:
input: target data set\hat{D}={(Xᵢ, cᵢ, loss)}, sampling rate ζ;
output: synthetic data set Ψ;
1) Ψ←{ };
2) for i=1 to ∥C∥do;
3) select all samples belonging to ci, denoted as (ci);
4) [cNum, cCenters, cSamples]=meanshift(\hat{D}(ci));
5) for j=1 to cNum do;
6) if ∥cSamples(j)∥>threshold, then:
7) Ψ←Ψ□metropolis-hastings(cCenters(j), cSamples(j), ζ);
8) else;
9) Ψ←Ψ□cSamples(j);
10) end if;
11) end for;
12) end for;
13) return Ψ.

Compared with the prior art, the invention has the following advantages: the invention proposes an energy-efficient sample selection method based on complexity, selects representative samples from large-scale datasets for efficient model training, and proves that sample complexity and model training strategies have a very important impact on the efficient training of deep neural networks, the invention solves the problem of low efficiency of model training based on sample complexity and model training strategies, the object of the energy-efficient sample selection method based on complexity is to select representative samples from large-scale data sets, thereby reducing the number of samples used for model training and achieving the object of lightweight training.

In inter-class sampling, all samples in the inverse diverse self-paced learning data setD={(xᵢ, cᵢ)} can be quantified by the loss value lossᵢ given by the model pre-trained by the inverse self-paced learning, denoted as Dₛ={(xᵢ, yᵢ, lossᵢ)}ᵢ₌₁^{i=k} wherein yᵢ∈C is the label p p=1 information and lossᵢ is the training loss of the sample xᵢ.

In intra-class sampling, samples within each class are iteratively selected based on the density distribution of the samples. The sampling rate refers to the proportion of samples selected from each class, for each iteration, density-based clustering is performed to connect regions in the sample set into clusters and exclude those noise samples that do not belong to the clusters. Considering that there may be significant differences in the loss distribution of clustering, therefore, the invention uses the mean shift algorithm to automatically find the number of clusters cNum and cluster centers cCenters, and use the number threshold to set the sampling strategy; when the number of samples in cluster j ∥cSample(j)∥ is greater than the threshold, it indicates that the cluster is dense and the number of samples is large; at the same time, in order to reduce the samples used for model training, a density-based Monte Carlo sampling algorithm is used to select representative samples from the cluster; for a cluster with fewer samples, all samples in the cluster are directly added to Ψ.

Further, the Monte Carlo sampling algorithm is as follows:
input: center, sample, sampling rate
output: selected sample set R;
1) R←{ };
2) Sample Number←∥Samples∥×ζ;
3) Set μ and δ as the mean and variance of clustering loss;
4) Initialize x⁽⁰⁾□N (μ, δ²);
5) While ∥R∥<SampleNumber do;
6) Propose the next candidate value x^{cand}□q(x⁽ⁱ⁾|xⁱ⁻¹);
7) Calculate acceptance probability:

$$α ( {x}^{cand} \vert {x}^{( i - 1 )} ) = min \{ 1 , \frac{q ( {x}^{( i - 1 )} \vert {x}^{cand} ) ω ( {x}^{cand} )}{q ( {x}^{cand} \vert {x}^{( i - 1 )} ) ω ( {x}^{( i - 1 )} )} \} ;$$

8) u ˜Uniform (u; 0, 1);
9) If u<α, then:
10) Accept the proposed value x⁽ⁱ⁾←x^{cand};
11) R←R□{x⁽ⁱ⁾};
12) end if;
13) end while;
14) return R.

### 4. DESCRIPTION OF EMBODIMENTS

In the embodiment of the invention, the invention provides a technical scheme: a energy-efficient sample selection method based on complexity, which performs sample selection on the raw data sets through two stages of inter-class sampling and intra-class sampling to achieve the object of constructing lightweight data set for model training. Wherein:
inter-class sampling, inter-class sampling is performed through reverse diverse self-paced learning, specifically the reverse diverse self-paced learning algorithm:
input: target data set D
output: model parameter w,
1) i←0; ←+∞; ←+∞;
2) if there is no prior clustering, then
3) set the number of clusters to the number of classes;
4) end if;
5) while not converged do;
6) update w*=argmin_{w}E(w, v*; λ, γ);
7) use Algorithm 1 to update v□=argminᵥE(w^{□}, v; λ, γ);
8) λ←(1−e⁻ⁱ)λ; γ←(1−e⁻ⁱ)γ;
9) i++;
10) end while;
11) return w=w^{□},
intra-class sampling is performed by a density-based sampling strategy, specifically an efficient intra-class sampling algorithm based on complexity:
input: target data set\hat{D}={(Xᵢ, cᵢ, loss)}, sampling rate ζ;
output: synthetic data set Ψ;
1) Ψ←{ };
2) for i=1 to ∥C∥do;
3) select all samples belonging to ci, denoted as (ci);
4) [cNum, cCenters, cSamples]=meanshift(\hat{D}(ci));
5) for j=1 to cNum do;
6) if ∥cSamples(j)∥>threshold, then:
7) Ψ←Ψ□metropolis-hastings(cCenters(j), cSamples(j), ζ);
8) else;
9) Ψ←Ψ□cSamples(j);
10) end if;
11) end for;
12) end for;
13) return Ψ.

The energy-efficient sample selection method based on complexity is a framework, which comprises the two stages of inter-class sampling and intra-class sampling. First, the inter-class sampling uses the reverse self-paced learning method to increase the learning of difficult samples of various classes, and realizes the adaptive adjustment of the learning weight of difficult samples. Then, intra-class sampling retains the difficult samples in each class and downsamples the easy samples through a clustering sampling algorithm based on the difficulty of the data samples. Finally, a lightweight data set is obtained.

In inter-class sampling, all samples in the inverse diverse self-paced learning data setD={(xᵢ, cᵢ)} can be quantified by the loss value lossᵢ given by the model pre-trained by the inverse self-paced learning, denoted as Dₛ={(xᵢ, yᵢ, lossᵢ)}ᵢ₌₁^{i=k}, wherein yᵢ∈C is the label information and lossᵢ is the training loss of the sample xᵢ.

In intra-class sampling, samples within each class are iteratively selected based on the density distribution of the samples. The sampling rate ζ refers to the proportion of samples selected from each class, for each iteration, density-based clustering is performed to connect regions in the sample set into clusters and exclude those noise samples that do not belong to the clusters. Considering that there may be significant differences in the loss distribution of clustering, therefore, the invention uses the mean shift algorithm to automatically find the number of clusters cNum and cluster centers cCenters, and use the number threshold to set the sampling strategy; when the number of samples in cluster j ∥cSample(j)∥ is greater than the threshold, it indicates that the cluster is dense and the number of samples is large; at the same time, in order to reduce the samples used for model training, a density-based Monte Carlo sampling algorithm is used to select representative samples from the cluster; for a cluster with fewer samples, all samples in the cluster are directly added to T.
input: center, sample, sampling rate
output: selected sample set R;
1) R←{ };
2) Sample Number<∥Samples∥×ζ;
3) Set 11 and 6 as the mean and variance of clustering loss;
4) Initialize x⁽⁰⁾ □N (μ, δ²);
5) While ∥R∥<SampleNumber do;
6) Propose the next candidate value x^{cand}□q(x⁽ⁱ⁾|xⁱ⁻¹);
7) Calculate acceptance probability:

$$α ( {x}^{cand} \vert {x}^{( i - 1 )} ) = min \{ 1 , \frac{q ( {x}^{( i - 1 )} \vert {x}^{cand} ) ω ( {x}^{cand} )}{q ( {x}^{cand} \vert {x}^{( i - 1 )} ) ω ( {x}^{( i - 1 )} )} \} ;$$

8) u ˜Uniform (u; 0, 1);
9) If u<α, then:
10) Accept the proposed value x⁽ⁱ⁾←x^{cand};
11) R←R□{x^{(i)};}
12) end if;
13) end while;
14) return R.

The pseudo code for Monte Carlo sampling is shown in Algorithm 4. The input parameters of Algorithm 4 comprise the cluster center Center, the loss distribution for the given cluster samples Samples, and the sampling rate ζ that controls how many samples are selected from each cluster. In Algorithm 4, our object is to synthesize the selected samples from each cluster into a selected sample data set R. First, we decide how many samples should be selected from a cluster by sampleNumber=|(|Samples|)|×ζ. To complete the sampling, we initialize x⁽⁰⁾ with cluster centers instead of random prior distributions to overcome getting stuck in local optima. In the main loop of Algorithm 4, first, a candidate solution x^{cand} is generated from the prior distribution q(x⁽ⁱ⁾|xⁱ⁻¹), and the acceptance probability of x^{cand} for the prior state x⁽ⁱ⁻¹⁾ is expressed as α(x^{cand}|x⁽ⁱ⁻¹⁾), then, calculating based on the prior distribution and the joint probability density w(*). Finally, comparing the acceptance probability a with a continuous uniform distribution u over the interval [0,1]. If u<α, the candidate solution is accepted and added to R as the selected sample. This process is repeated continuously until the size of R reaches the sampling threshold SampleNumber, and the algorithm stops.

The basic principles, main features and advantages of the invention are shown and described above. Those skilled in the art should understand that the invention is not limited by the above embodiments, the descriptions in the above embodiments and the specification are only for illustrating the principle of the invention, without departing from the spirit and scope of the invention, the invention may have various changes and improvements, and these changes and improvements all fall within the protection scope of the invention. The protection scope of the invention is defined by the appended claims and their equivalents.

1. An energy-efficient sample selection method based on complexity, wherein the lightweight data set is constructed by efficient sample selection for model training, and the method comprises two stages of inter-class sampling and intra-class sampling, wherein:
inter-class sampling, inter-class sampling is performed through reverse self-paced learning with diversity, specifically the reverse self-paced learning with diversity algorithm is shown below:
input: target data set D
output: model parameter w,
1) i←0; ←+∞; ←+∞;
2) if there is no prior clustering, then
3) set the number of clusters to the number of classes;
4) end if;
5) while not converged do;
6) update w*=argmin_{w}E(w, v*; λ, γ);
7) use Algorithm 1 to update v□=argminᵥE(w^{□}, v; λ, γ);
8) λ←(1−e⁻ⁱ)λ; γ←(1−e⁻ⁱ)γ;
9) i++;
10) end while;
11) return w=w^{□};
intra-class sampling is performed by a density-based sampling strategy, specifically an efficient intra-class sampling algorithm based on complexity:
input: target data set\hat{D}={(Xᵢ, cᵢ, loss)}, sampling rate ζ;
output: synthetic data set Ψ;
1) Ψ←{ };
2) for i=1 to ∥C∥do;
3) select all samples belonging to ci, denoted as (ci);
4) [cNum, cCenters, cSamples]=meanshift(\hat{D}(ci));
5) for j=1 to cNum do;
6) if ∥cSamples(j)∥>threshold, then:
7) Ψ←Ψ□metropolis-hastings(cCenters(j), cSamples(j), ζ);
8) else;
9) Ψ←Ψ□cSamples(j);
10) end if;
11) end for;
12) end for;
13) return Ψ.

2. An energy-efficient sample selection method based on complexity according to claim 1, wherein for inter-class sampling, all samples in the inverse diverse self-paced learning data setD={(xᵢ, cᵢ)} can be quantified by the loss value lossᵢ given by the model pre-trained by the inverse self-paced learning, denoted as Dₛ={(xᵢ, yᵢ, lossᵢ)}ᵢ₌₁^{i=k}, wherein yᵢ∈C is the label information and lossᵢ is the training loss of the sample xᵢ; for intra-class sampling, samples within each class are iteratively selected based on the density distribution of the samples.

3. An energy-efficient sample selection method based on complexity according to claim 1, wherein in an efficient sample intra-class sampling algorithm, the sampling rate refers to the proportion of samples selected from each class, for each iteration, density-based clustering is performed to connect regions in the sample set into clusters and exclude those noise samples that do not belong to the clusters.

4. An energy-efficient sample selection method based on complexity according to claim 3, wherein there may be significant differences in the loss distribution of clustering, the mean shift algorithm is used to automatically find the number of clusters cNum and cluster centers cCenters, and the number threshold is used to set the sampling strategy; when the number of samples in cluster j ∥cSample(j)∥ is greater than the threshold, it indicates that the cluster is dense and the number of samples is large; at the same time, in order to reduce the samples used for model training, a density-based Monte Carlo sampling algorithm is used to select representative samples from the cluster; for a cluster with fewer samples, all samples in the cluster are directly added to Ψ.

5. An energy-efficient sample selection method based on complexity according to claim 4, wherein the Monte Carlo sampling algorithm is as follows:
input: center, sample, sampling rate ζ;
output: selected sample set R;
input: center, sample, sampling rate ζ;
output: selected sample set R;
1) R←{ };
2) Sample Number←∥Samples∥×ζ;
3) Set μ and δ as the mean and variance of clustering loss;
4) Initialize x⁽⁰⁾□N (μ, δ²);
5) While ∥R∥<SampleNumber do;
6) Propose the next candidate value x^{cand}□q(x⁽ⁱ⁾|xⁱ⁻¹);
7) Calculate acceptance probability:
$$α ( {x}^{cand} \vert {x}^{( i - 1 )} ) = min \{ 1 , \frac{q ( {x}^{( i - 1 )} \vert {x}^{cand} ) ω ( {x}^{cand} )}{q ( {x}^{cand} \vert {x}^{( i - 1 )} ) ω ( {x}^{( i - 1 )} )} \} ;$$
8) u ˜Uniform (u; 0, 1);
9) If u<α, then:
10) Accept the proposed value x⁽ⁱ⁾←x^{cand};
11) R←R□{x⁽ⁱ⁾};
12) end if;
13) end while;
14) return R.
